(19) United States
(12) Patent Application Publication
(10) Pub. No.: US 2002/0126504 A1
(43) Pub. Date: Sep. 12, 2002

(54) Aquarium light

(76) Inventor: Karim E. Mansour, Dunedin, FL (US)

Correspondence Address: Low and Low, P.O. Box 2184, Arlington, VA, 22202, US

(21) Appl. No.: 10/060,381

(22) Filed: Feb. 1, 2002

Related U.S. Application Data
(60) Provisional application No. 60/293,033, filed on Feb. 2, 2001.

(51) Int. Cl. F21V 7/04

(52) U.S. Cl. 362/555

(57) ABSTRACT

The Aquarium lighting system comprises a light source and a cable of individual fiber optic strands which deliver light of varying hues or tints to within the interior of an aquarium.

### BACKGROUND

This version of the invention is concerned with the field of aquarium lighting systems. More specifically, this version of the invention is concerned with aquarium lighting systems that comprise a light source and a cable of individual fiber optic strands that delivers light of varying hues or tints to within the interior of an aquarium.

### PRIOR ART

Aquariums (and to a lesser extent terrariums) have increased in popularity recently as people have come to appreciate the natural environment and its ecosystems and thus seek ways to create or arrange self-contained natural environments and arrange them within their homes, places of work or recreation, and the like. In general aquariums are comprised of a clear tank, hood with light source, filtration and aeration systems, water, and a variety of gravel or sandy bottom material, vegetation, rocks, and other decorative items. The light source is situated within the tank hood and is shielded from view so that its light reflects downward into the tank in order to illuminate the fish and provide, if necessary, the light necessary for photosynthesis of any submerged aquatic vegetation or SAV. The light sources generally consist of fluorescent lamps with associated power switch and transformer, incandescent lamp(s), or miscellaneous sources such as light emitting diodes (LEDs) These light sources are adequate to provide illumination for simple viewing but typically do not furnish the proper color rendition to provide a lifelike appearance of fish and vegetation or the means by which the viewing experience can be enhanced by, for instance, varying the color spectrum or hue of the light source. Additionally, such light sources are mounted, shielded, or otherwise constructed in a manner that prevents their being splashed with water in order to prevent the possibility of an electrical short circuit or damage to marine life. Such methods of construction, while intended for electrical and marine safety, nevertheless interfere with the ability of the light source to deliver unobstructed or unadulterated light.

What is needed then to overcome the limitations and disadvantages of conventional light sources and lighting systems for aquariums is the provision of an aquarium light that employs a novel means to vary and transmit the hue of light emanating from a light source to the interior of an aquarium. Such a means would consist in part of a conventional incandescent or halogen lamp with reflector, power delivery system, housing, rotating color wheel, and fiber optic cable with individual strands.

### DISCUSSION OF THE PRIOR ART

Numerous designs for aquarium lighting systems have been provided in the prior art. Even though these designs may be suitable for the specific individual purposes to which they address, they would not be suitable for the purposes of the present version of the invention as such lighting systems do not include the means to vary the hue of light emanating from a light source or do not employ fiber optic cable for delivery of such light. These designs are exemplified by U.S. Pat. No. 5,165,778, Aquarium Lighting System, issued to Matthias et al. on Nov. 24, 1992; U.S. Pat. No. 5,211,469, Aquarium, Lighting System, issued to Matthias et al. on May 18, 1993; U.S. Pat. No. 5,406,641, Flexible Light Pipe, Cured Composite And Processes For Preparation Thereof, issued to Bigley, Jr. et al. on Apr. 11, 1995; U.S. Pat. No. 5,597,229 Aquarium Landscape System, issued to Boyle on Jan. 18, 1997; and U.S. Pat. No. 6,086,215, Aquarium And Associated Laser Device And Method Of use therefore, issued to Giattino et al. on Jul. 11, 2000.

As such, it may be appreciated that there is a continuing need for a new and improved aquarium lighting system with means to deliver unadulterated light of varying hues to the interior of an aquarium tank without risking the possibility of incurring electrical shock or short circuiting, or damage to marine life. In these respects, the present version of the invention substantially departs from the conventional concepts and designs of the prior art, and in so doing provides an apparatus that substantially fulfills this need. Additionally, the prior patents and commercial techniques do not suggest the present inventive combination of component elements arranged and configured as disclosed herein.

The present invention achieves its intended purposes, objects, and advantages through a new, useful and unobvious combination of method steps and component elements, with the use of a minimum number of functioning parts, at a reasonable cost to manufacture, and by employing only readily available materials.

### SUMMARY

The present version of the invention, which will be described in greater detail hereinafter, relates to the field of aquarium lighting systems. More specifically, this version of the invention is concerned with aquarium lighting systems that comprise a light source and a cable of individual fiber optic strands that delivers light of varying hues or tints to within the interior of an aquarium. My version of the invention overcomes all of the shortcomings listed previously, in addition to novel aspects that will be described in detail hereinafter.

Described briefly, according to a typical embodiment, the invention presents an aquarium light source that is designed to be releasably attached to the side of an aquarium tank in order to deliver clear light of varying hues to the interior of said tank while segregating the light and power sources at a distance from the water within said tank so as to prevent the possibility of an electrical shock or short circuit or damage to marine life. The aquarium light source is comprised of a rectangular housing or case fabricated of clear Plexiglas, cable of fiber optic strands attached onto a top side wall thereof, and a electric power line attached to a lateral side wall thereof. A chassis, situated within the case, is attached to the top and bottom side walls thereof and supports a transformer, low voltage electric motor, and light source thereon. The electric power line enters through a lateral side wall of the case and is connected to the transformer. Another power line, transmitting stepped down current from the transformer, is connected to the electric motor, and light source. A shaft is connected to the electrical motor at a first end and is connected at a second end to a color wheel. The light source is comprised of a halogen lamp with reflector and socket, which is attached directly to the chassis. The exterior power line is fitted with a rotating on/off switch; additional control is provided by a pause button, which can suspend rotation of the color wheel during operation.

The light source is centrally attached to the chassis so that the lamp directs a beam of light to the medial portion of the top side wall onto which the fiber optic cable is attached. In this manner, light generated by the light source and modulated in hue or intensity by the rotating color wheel can be transmitted to the fiber optic cable for delivery to the interior of the aquarium tank. The fiber optic cable is fabricated into a serpentine configuration and is comprised of an outer sheath encasing 150 strands of fiber optic material. Cable fastener conduits with suctions cups attached thereon are fitted over the sheath. The suction cups attach the fiber optic cable to the side of the aquarium tank.

A first end of the fiber optic cable is attached directly to an interface coupling, which as affixed to the top side wail of the case over an aperture formed therein. Light emanating from the light source passes through an aperture fabricated into the coupling and communicates directly with the end of the fiber optic cable, which transmits said light to the distal end of said cable for illumination of an aquarium tank. The distal end of the fiber optic cable is comprised of the individual strands configured into a plume shape so that 150 individual points of light can be distributed to various locations within said aquarium tank.

My invention, therefore, resides not in any one of these features per se, but rather in the particular combination of all of them herein disclosed. It is distinguished from the prior art in this particular combination of all of its structures for the functions specified.

In order that the detailed description of the invention may be better understood and that the present contribution to the art can be more fully appreciated, additional features of the invention will be described hereinafter. It should be appreciated by those skilled in the art that the conception and the disclosed specific methods and structures may be readily utilized as a basis for modifying or designing other structures for carrying out the same purposes of the present invention. It should be realized by those skilled in the art that such equivalent methods and structures do not depart from the spirit and scope of the invention.

In this respect, before explaining at least one embodiment of the invention in detail, it is to be understood that the invention is not limited in its application to the details of constriction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application nor is it intended to be limiting as to the scope of the invention in any way.

Accordingly, it is an object of my version of the invention to provide a low-cost, easy-to-manufacture, and easy-to-market aquarium light.

A further object of my version of the invention is to provide an easy-to-use and versatile aquarium light.

A significant object of the invention is to provide an aquarium light that is comprised of a case, chassis, transformer, low voltage electric motor and light source with color wheel, power line and control switches, fiber optic cable, and means of attaching said cable to the side wall of an aquarium tank.

A final but very significant object of the invention is to provide an aquarium light need constructed with means to deliver unadulterated light of varying hues or intensity to one or more locations within the interior of an aquarium tank without risking the possibility of incurring electrical shock or short circuiting, or damage to marine life.

For a better understanding of the invention, its operating advantages and the specific objects attained by its uses, reference should be made to the accompanying drawings and descriptive matter in which there is illustrated a preferred embodiment of the invention. The foregoing has outlined some of the more pertinent objects of the invention. These objects should be construed to be merely illustrative of some of the more prominent features and applications of the present invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiment in addition to the scope of the invention illustrated by the accompanying drawings.

### BRIEF DESCRIPTION OF THE DRAWINGS

The foregoing and other objects, features and advantages of the invention will become more fully understood from the following description of the preferred embodiment of the invention as illustrated in the accompanying drawings in which like reference characters refer to the same parts throughout different views. The drawings are not necessarily to scale, emphasis instead being placed upon illustrating the principles of the invention.

FIG. 1 is an elevation view of the front of the aquarium light in accordance with the present version of the invention.

FIG. 2 is an elevation view of the right side of the aquarium, light in accordance with the present version of the invention.

FIG. 3 is an elevation view of the rear of the aquarium light in accordance with the present version of the invention.

FIG. 4 is an elevation view of the left side of the aquarium light in accordance with the present version of the invention.

FIG. 5 is a top plan view of the aquarium light in accordance with the present version of the invention.

### DRAWING REFERENCE NUMERALS

1 Case

2 Coupling

3 Chassis

4 Color Wheel

5 Drive Shaft

6 Fastener

7 Light Source

8 Transformer

9 Electric Motor

10 Power Line

11 Power Switch

12 Fasteners

13 Bushing

14 Wire

15 Fiber Optic Cable

16 Conduit

17 Suction Cups

18 Socket

19 Hose Clamp

20 Bracket

21 Pause Switch

### DESCRIPTION OF THE PREFERRED EMBODIMENT

DESCRIPTION

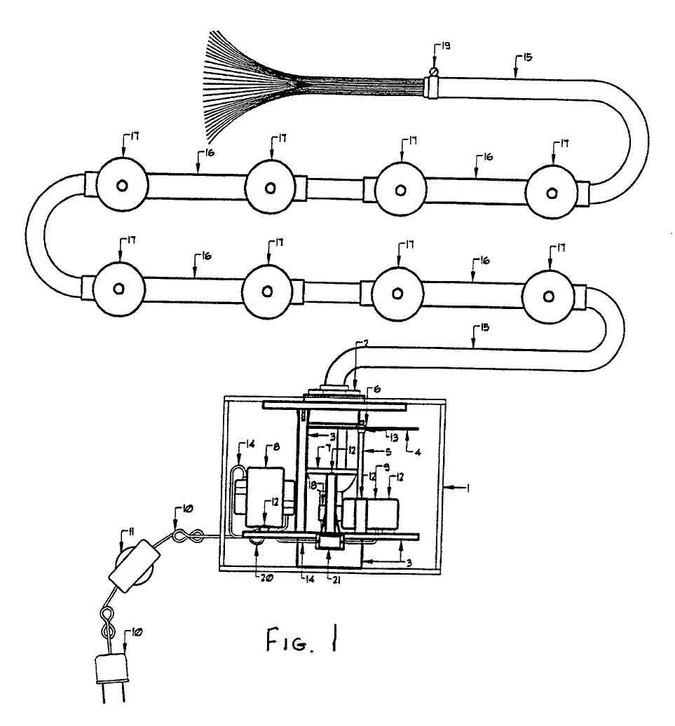

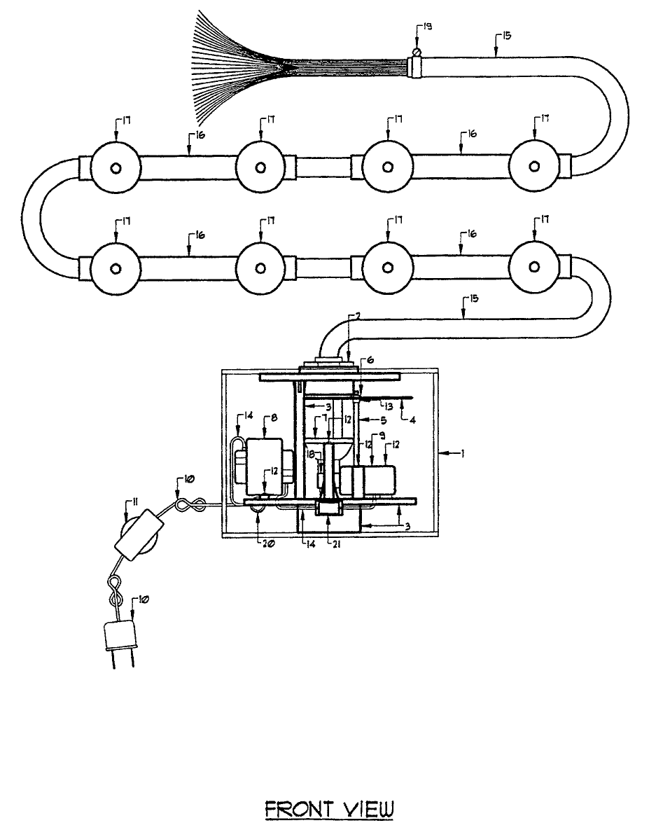

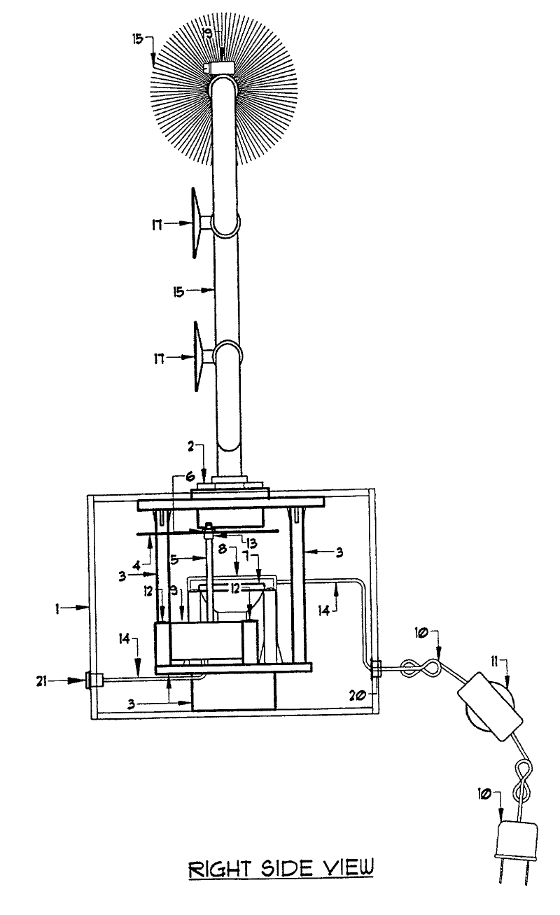

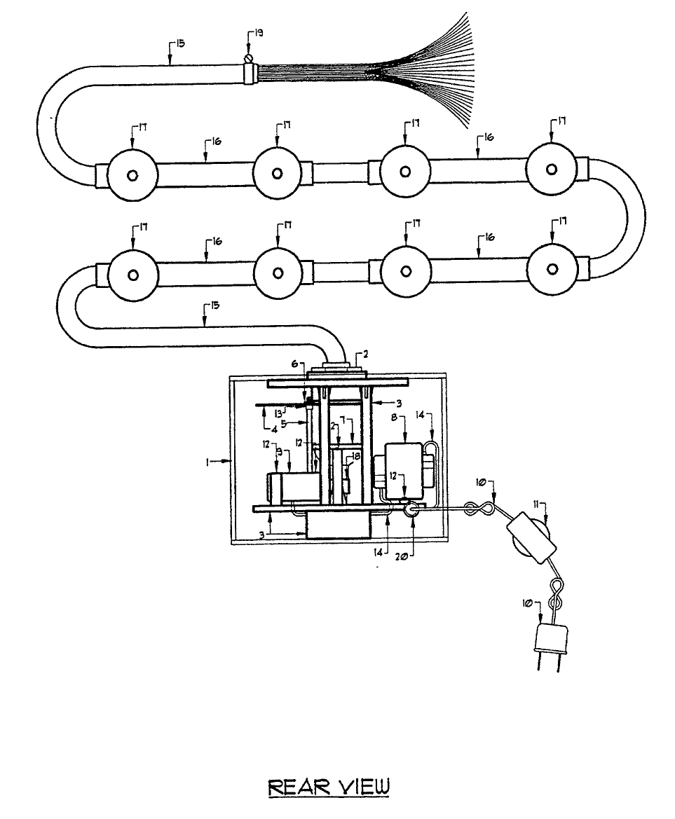

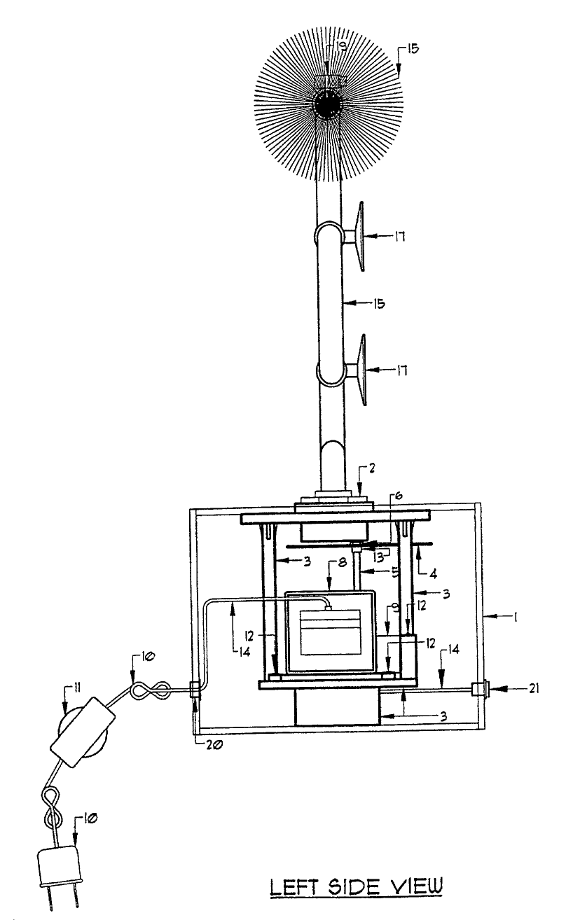

Referring now to the drawings and, in particular, to FIG. 1 to FIG. 5 wherein there are illustrated a typical embodiment of the aquarium light 10. The present version of the invention 10 is comprised of a rectangular case 1, coupling 2 attached to the top side wall of said case 1, chassis 3, illuminator, and fiber optic cable 15. The rectangular case 1 is constructed as a cube of four lateral side walls and a top and bottom side wall of material that is lightweight, durable, and transparent, such as Plexiglas or the like. An aperture, which is formed into the top side wall of the case 1, communicates with an aperture formed centrally within the coupling 2. Additional apertures are formed into the lateral side walls of the case 1 for accommodation of a power line and switch, which will be described later in this disclosure.

The illuminator is an assembly of components that produces a light beam, which is transmitted to the fiber optic cable 15 for ultimate delivery to the interior of an aquarium tank. The illuminator consists of a color wheel 4 with drive shaft 5 and fastener that secures the color wheel 4 to the drive shaft 5; light source 7; low voltage transformer 8; electric motor 9. The color wheel 4 is constructed of lightweight, translucent plastic of at least four different hues and is attached to one end of the drive shaft 5 by a threaded fastener 6 and aligned thereon by a bushing 13.

The light source 7, which is supported over the chassis 3 by means of a ceramic, screw socket 18, is comprised of a 12 volt incandescent halogen lamp with built-in reflector. A low voltage transformer 8 receives incoming house power of 110-120 VAC from a power line 10 with rotating on-off switch 11. The power line 10 is inserted through an aperture formed into a lateral side wall of the case 1 and is connected to the transformer 8. The incoming electric power is reduced to 12 VAC and is delivered first to the electric motor 9 and then to the light source 7 by means of a wire 14. The electric motor 9 is attached directly to the chassis 3 and receives the drive shaft 5 with color wheel 4 attached thereon.

The motor 9 operates at 12 volts and is furnished with a gear reduction device, which rotates the shaft 5 and color wheel 4 at approximately 6-8 revolutions per minute. Threaded screw fasteners 12 attach the light source 7, transformer 8, and electric motor 9 to the chassis 3. Additionally, a flush mount bracket 20, secured to the under side of a portion of the chassis 3, assists in fastening the transformer 8 to said portion of chassis 8.

The fiber optic cable 15 is comprised of 150 individual fiber optic strands, the majority of which are enclosed in a protective sheath. The cable 15 is fitted with a series of conduits 16 with suction cups 17 attached thereto. A first end of the cable 15 is attached to the coupling 2, and a second end thereof is constricted by a clamp 19, which is fitted over the sheath and allows the exposed strands of cable 15 to be configured into a plume shape. The suction cups 17 are releasably attached to the side wall of an aquarium tank in order to support the fiber optic cable 15 at an optimum position and to allow the end of the cable 15 configured as a plume to be inserted into the tank and under water at one or more locations therein.

The coupling 2, which is secured to the side edge enclosing an aperture formed into the top side wall of the case 1, is fabricated with an aperture into which the first end of the cable 15 is inserted. In this manner, light emanating from the light source 7 is transmitted to the exposed end of fiber optic cable 15 secured within the coupling and delivered to the second end of the cable 15 at the plume. Under certain conditions, the plume can be configured to provide 150 points of light within the aquarium tank. As the color wheel 4 rotates, various hues of light are delivered to the fiber optic cable 15, thereby varying the light delivered to the tank and enhancing the viewer's experience. If a viewer desires to observe a particular hue of light for a period longer than that allowed by normal operation of the color wheel 4, a pause switch 21 can be actuated to suspend rotation of the color wheel 4 at a particular hue.

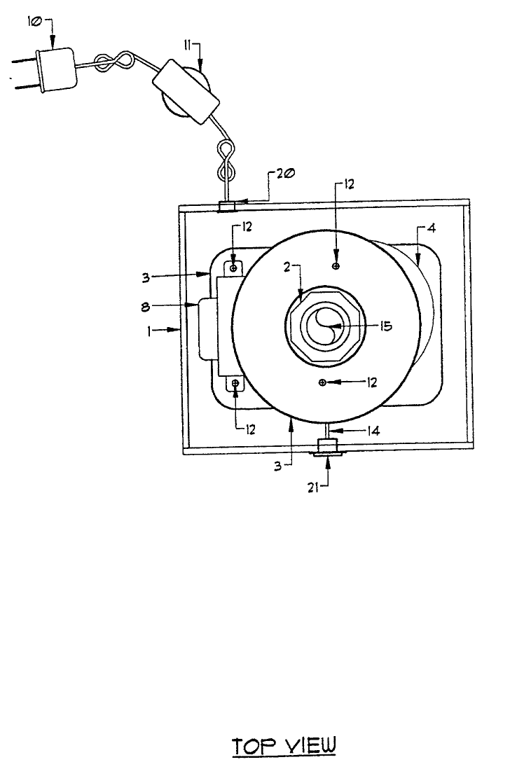

For routine maintenance, such as replacing the light source 7, the top side wall of the case 1 can be detached from a the body of the case 1 by removing threaded screw fasteners 12. As shown in FIG. 5, the fasteners 12 attach the top side wall of the case 1 to a circular portion the chassis 3, thereby securing the top side wall to the lateral side walls of the case 1 in a manner that prevents water and moisture from entering the interior of the case 1.

While this version of the invention has been illustrated and described in detail in the drawings and foregoing description, the same is to be considered as illustrative and not restrictive in character, it being understood that only the preferred embodiment has been shown and described and that all changes and modifications that come within the spirit of the version of the invention are desired to be protected. With respect to the above description then, it is to be realized that the optimum dimensional relationships for the parts of the invention, to include variations in size, materials, shape, form, function and manner of operation, assembly and use, are readily apparent and obvious to one skilled in the art, and all equivalent relationships to those illustrated in the drawings and described in the specification are intended to be encompassed by the present invention.

CONCLUSION AND SCOPE OF INVENTION

From the foregoing, it will be understood by persons skilled in the art that an improved aquarium light has been provided. The invention is relatively simple and easy to manufacture, yet affords a variety of uses. While my description contains many specificities, these should not be construed as limitations on the scope of the version of the invention, but rather as an exemplification of the preferred embodiment thereof. The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be resorted to, falling within the scope of the invention. Although this invention has been described in its preferred form with a certain degree of particularity, it is understood that the present disclosure of the preferred form has been made only by way of example and numerous changes in the details of construction and combination and arrangement of parts may be resorted to without departing from the spirit and scope of the invention.

I claim:

1. An aquarium light system including a housing, a light source within said housing, a color wheel positioned within said housing to receive light from said light source, means for rotating said color wheel, and at least one fiber-optic cable comprising a plurality of fiber-optic strands, wherein a first end of said fiber-optic cable is positioned within said housing to receive light transmitted through said color wheel and a second end of said fiber-optic cable is positioned within the aquarium to be lighted.
